(19) United States
(12) Patent Application Publication
(10) Pub. No.: US 2026/0044759 A1
(43) Pub. Date: Feb. 12, 2026

(54) USER-SPECIFIC MODEL TRAINING USING DATA FROM A SET OF USERS AND PROBALISTIC MIXTURE MODELS

(71) Applicant: Salesforce, Inc., San Francisco, CA (US)

(72) Inventors: Donglin Hu, Dublin, CA (US); Brian Brechbul, Indianapolis, IN (US)

(21) Appl. No.: 18/795,607

(22) Filed: Aug. 6, 2024

(51) Int. Cl. G06N 7/00

(52) U.S. Cl. CPC G06N 7/00

(57) ABSTRACT

In some systems, users may fine-tune a user-specific machine learning (ML) model. For example, a system may receive a first set of data from a first user and a second set of data from a second user that has a different size than the first set of data. The system may then input the first and second set of data into a probabilistic mixture model to obtain a set of global training parameters that includes a cluster proportions parameter, a cluster means parameter, and a cluster covariance parameter. Further, the system may generate an updated global training parameter for training an ML model for the first user and an updated global training parameter for training an ML model associated with the second user. Moreover, a quantity of updated global training parameters generated for a user may be based on the size of a set of data associated with the user.

### FIELD OF TECHNOLOGY

The present disclosure relates generally to database systems and data processing, and more specifically to user-specific model training using data from a set of users and probabilistic mixture models.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, users may use machine learning (ML) models to determine common characteristics or behaviors between customers. In some cases, the users may then use the common characteristics or behaviors to generate customer segmentations via a ML model. However, in some examples, users that have a relatively low quantity of data may be unable to use a ML model to generate customer segmentations. For example, ML models may be trained on user data and having a low quantity of data may prevent a user from being able to accurately train an ML model. Additionally, or alternatively, users with a relatively large quantity of data for training an ML model but a relatively low quantity of data associated with customers for customer segmentation. In such cases, users may be capable of training an ML model, but the customer segmentations generated by the ML model may be relatively inaccurate due to a lack of relevant training data.

### BRIEF DESCRIPTION OF THE DRAWINGS

FIG. 1 illustrates an example of a system that supports user-specific model training using data from a set of users and probabilistic mixture models in accordance with aspects of the present disclosure.

FIG. 2 shows an example of a model training flow diagram that supports user-specific model training using data from a set of users and probabilistic mixture models in accordance with aspects of the present disclosure.

FIG. 3 shows an example of a process flow that supports user-specific model training using data from a set of users and probabilistic mixture models in accordance with aspects of the present disclosure.

FIG. 4 shows a block diagram of an apparatus that supports user-specific model training using data from a set of users and probabilistic mixture models in accordance with aspects of the present disclosure.

FIG. 5 shows a block diagram of a parameter tuning module that supports user-specific model training using data from a set of users and probabilistic mixture models in accordance with aspects of the present disclosure.

FIG. 6 shows a diagram of a system including a device that supports user-specific model training using data from a set of users and probabilistic mixture models in accordance with aspects of the present disclosure.

FIG. 7 shows a flowchart illustrating methods that support user-specific model training using data from a set of users and probabilistic mixture models in accordance with aspects of the present disclosure.

### DETAILED DESCRIPTION

In some examples, users or tenants may use machine learning (ML) clustering techniques to group or segment customers of services based on common characteristics and behaviors. Thus, users or tenants may use ML clustering techniques to generate customer segmentations via an ML model. The customer segmentations may be groupings of customers that a user or tenant can use to improve marketing campaigns, provide more customized and personalized customer experiences, and the like. To generate such customer segmentations, users or tenants may have to use a relatively large quantity of relatively high quality data (e.g., data relevant to customer characteristics and behaviors) to train an ML model. For example, an ML model for a user may be trained on user-specific data to analyze behavior and engagement patterns of customers to extract features of the customers to then generate customer segmentation groups. However, if a user has a relatively low quantity of data for training an ML model or has relatively low quality data for training an ML model, the user may be unable to train the ML model to generate accurate customer segmentations.

The techniques of the present disclosure may describe using data from a set of users to obtain a set of global training parameters to assist and fine-tune the training of a local ML model for a user. For example, a system (e.g., a model training service) may receive a first set of data from a first user of a set of users and a second set of data from a second user of the set of users. Moreover, the first set of data and the second set of data may have different sizes (e.g., the quantity of data within the first set of data and the second set of data is different). The system may use the first set of data and the second set of data as inputs into a probabilistic mixture model (e.g., a Gaussian mixture model) to obtain a set of global training parameters that are associated with the set of users. The set of global training parameters may include a first parameter associated with cluster proportions, a second parameter associated with cluster means, and a third parameter associated with a cluster covariance. Further, the system may generate at least one updated (e.g., fine-tunes) global parameter for training a first ML model for the first user, for training a second ML model for the second user, or both, where a quantity of updated global training parameters generated for a respective user is based on a size of the data associated with the user. Therefore, the techniques of the present disclosure may enable users to train and fine-tune ML models based on global training parameters thus ensuring that the ML models generate accurate and reliable results.

In some examples, a third user that has a relatively low quantity of data or no data may use the global training parameters to train a ML model. For example, rather than being unable to train and use a ML model due to a lack of data, in accordance with the techniques of the present disclosure, the third user may use the global training parameters to train an ML model. Further, to obtain the global training parameters, the system may generate a combined set of data of each user of the set of users for the input to the probabilistic mixture model. In some cases, in accordance with the techniques of the present disclosure, when training a local ML model for a user, the system may use the set of data associated with the user to perform a training parameter calibration procedure to obtain an updated global training parameter. In some other cases, users associated with higher quantities of data and higher quality data, a user may use the training parameter calibration procedure to update additional global training parameters to further fine-tune a local ML model for the user.

Aspects of the disclosure are initially described in the context of an environment supporting an on-demand database service. Additional aspects of the disclosure are described with reference to a model training flow diagram and a process flow. Aspects of the disclosure are further illustrated by and described with reference to apparatus diagrams, system diagrams, and flowcharts that relate to user-specific model training using data from a set of users and probabilistic mixture models.

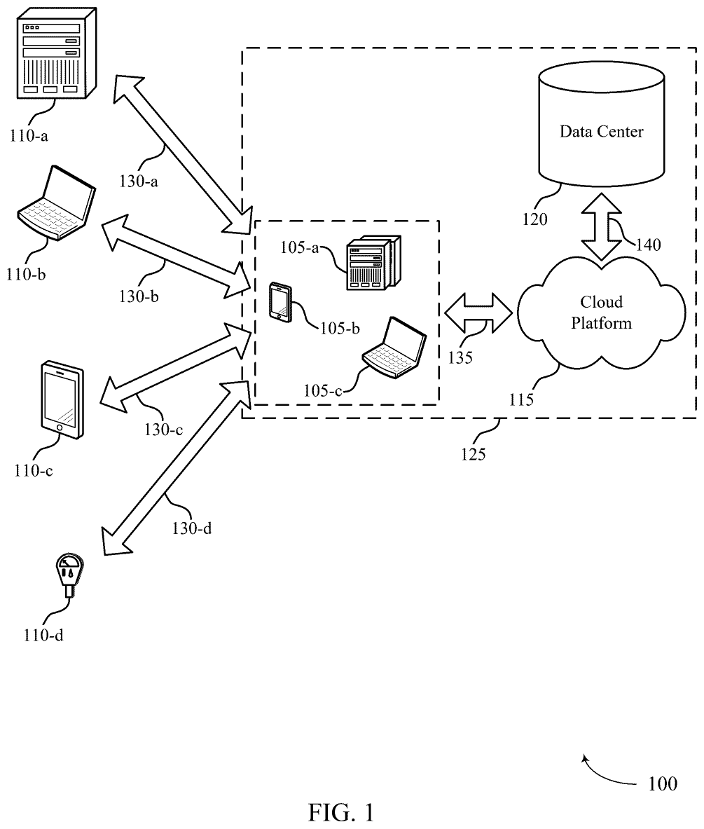

FIG. 1 illustrates an example of a system 100 for cloud computing that supports user-specific model training using data from a set of users and probabilistic mixture models in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with the same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, users or tenants of the system 100 may use ML clustering techniques to group or segment customers of services based on common characteristics and behaviors. In some cases, a user (e.g., a user of a cloud client 105 or a contact 110) may use a ML model that is locally hosted on a cloud client 105 or a contact 110 or that is cloud-based and is hosted on the cloud platform 115. For example, users may use the ML clustering techniques to generate customer segmentations via an ML model to improve marketing campaigns, provide more customized and personalized customer experiences, and the like. To generate such customer segmentations, users may have to use a relatively large quantity of relatively high quality data (e.g., data relevant to customer characteristics and behaviors) to train an ML model. For example, an ML model for a user may be trained on user-specific data to analyze behavior and engagement patterns of customers to extract features of the customers to then generate customer segmentation groups. However, if a user has a relatively low quantity of data, the user may be unable to train an ML model to generate customer segmentations due to the lack of data. Additionally, or alternatively, a user may have a quantity of data for training an ML model but the data may have a relatively low quality. For example, the set of data associated with the user may be irrelevant to customer characteristics and behaviors and if used to train an ML model to generate customer segmentations, the results of the ML model may be relatively inaccurate and unreliable.

In accordance with the techniques of the present disclosure, the system 100 may cluster data from a set of users to be used as an input for a probabilistic mixture model. The system 100 may then obtain a set of global training parameters for training local ML models from the probabilistic mixture model. In some cases, the set of global training parameters may include a first parameter associated with cluster proportions, a second parameter associated with cluster means, and a third parameter associated with a cluster covariance.

Using the global training parameters, users may train and fine-tune ML models based on a quantity of data and a quality of data associated with the user. For example, a user with a relatively low quantity of data may train a local ML model by directly using the global training parameters. In another example, users with a relatively average quantity of data may fine-tune one or more of the global training parameters prior to using the global training parameters for ML model training. For example, a first user may generate an updated cluster proportions parameter using the set of data associated with the first user. The first user may then train a local ML model using the updated cluster proportions parameter, the non-updated cluster means parameter, the non-updated cluster covariance parameter, and the set of data associated with the first user. In some other examples, if a user has a relatively high quantity of data that is of a relatively high quality, a user may update all the global training parameters with the set of data associated with the user. In such examples, the local ML model training may be boosted or enhanced by using both user-specific data and the global training parameters. Therefore, the techniques of the present disclosure may enable users to train and fine-tune ML models based on user-specific data, global training parameters, or both to provide more robust ML model training resulting in more accurate and reliable results from the ML models.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

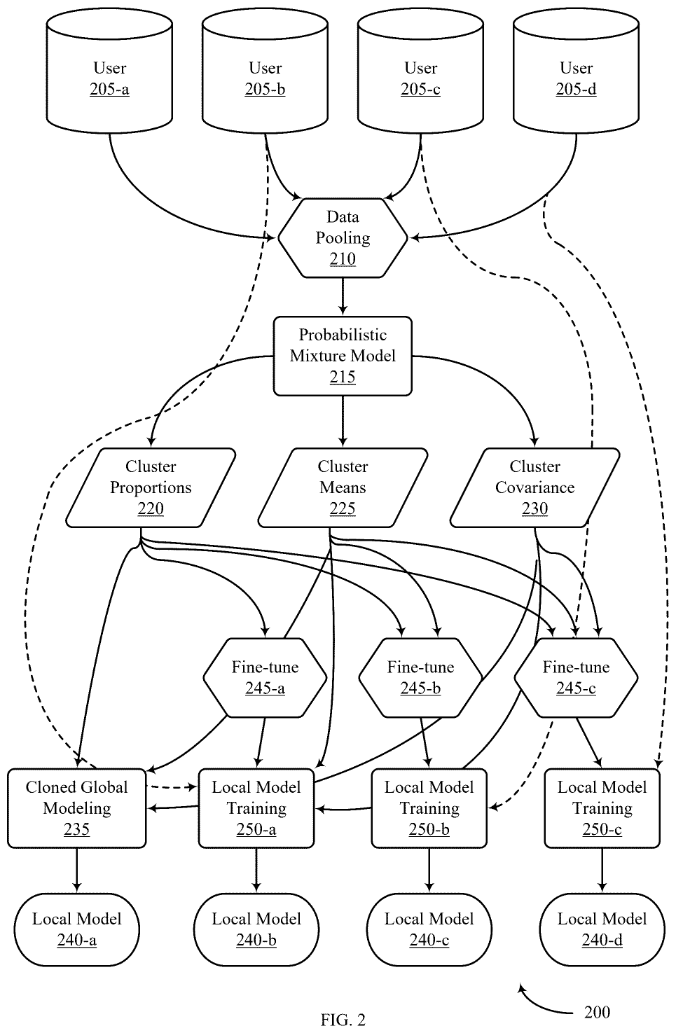

FIG. 2 shows an example of a model training flow diagram 200 that supports user-specific model training using data from a set of users and probabilistic mixture models in accordance with aspects of the present disclosure. In some examples, the model training flow diagram 200 may implement or be implemented by the system 100. For example, the model training flow diagram 200 may be performed by devices described herein with reference to FIG. 1, such as a cloud client 105, a contact 110, or a service (e.g., a model training service) hosted on the cloud platform 115. Further, the model training flow diagram 200 may illustrate the process of clustering data from multiple users 205 of a set of users (e.g., a user 205-a, a user 205-b, a user 205-c, and a user 205-d) to generate local models 240 for each user 205 (e.g., a local model 240-a, a local model 240-b, a local model 240-c, and a local model 240-d).

In some examples, as described elsewhere herein, users 205 may use ML clustering techniques to generate customer segmentations via a ML model. For example, a user (e.g., a tenant of a multi-tenant system, an organization, a business, and the like) may use clustering techniques to group customers based on similar characteristics (e.g., purchasing behavior, demographics, preferences, or any combination thereof). Using the segmentation, users may be able to generate more targeted marketing strategies and campaigns as well as more personalized customer experiences. For example, a user may use a first version of a marketing campaign message (e.g., an email, text message, and the like) for a first customer segmented group and a second version for a second customer segmented group based on the common characteristics of a respective segmentation group. Further, in some cases, a user may provide groups of customers with access to additional features (e.g., features that are in a beta-testing phase) based on the common characteristics of the customers.

To generate the customer segmentation, data quality and quantity may be relatively important for building a reliable clustering system. In some examples, models may be trained using data from a single user or organization. For example, a system may analyze the behaviors and engagement patterns of customers of an organization to extract features as inputs. However, such systems may be unreliable or inaccurate due to over-fitting if the quantity of data samples are relatively low. For example, an ML model may be able to remember the patterns of the training data and may make inaccurate predictions with unseen data (e.g., input data after the training of the ML model). Moreover, while users 205 associated with smaller organizations (e.g., the user 205-a) may suffer from a lack of data, users 205 associated with larger organizations (e.g., the user 205-d) may also experience inaccurate ML model predictions due to a lack of relevant data for some customer segments or a lack of relatively high quality data.

In accordance with the techniques of the present disclosure, to ensure that each user 205 may be capable of having access to an accurate ML model, a global model may be trained using a combination of the data from the set of users 205. For example, the data from the user 205-a, the user 205-b, the user 205-c, and the user 205-d may be pooled together via a data pooling procedure 210. The combined user 205 data from the data pooling procedure 210 can be input into a probabilistic mixture model 215 (e.g., a Gaussian mixture model). In some cases, the probabilistic mixture model 215 may generate a false assumption that each user 205 will behave the same, however, a portion of the pooled user 205 data can assist in improving the performance of a model that is local to a respective user 205. Moreover, while the remainder of the pooled user 205 data may be noise and can be harmful to model predictions (e.g., customer segmentation generations), the ML models used by the users 205 may be capable of extracting the useful information from the pooled data while ignoring or discarding the noise in the system. Additionally, or alternatively, as users 205 associated with small to medium organizations (e.g., the user 205-a, the user 205-b, and the user 205-c) may have relatively low quantities of data available, training a ML model using user 205 specific data may be relatively difficult. Thus, the techniques of the present disclosure may enable the respective users 205 to gradually train a customized clustering model using a relatively small quantity of local samples by utilizing a set of global training parameters obtained from the probabilistic mixture model 215.

In some examples, it can be assumed that the observations coming from the data pooling procedure 210, Xᵢ, follows a mixture model with K mixture components. Therefore, the probability density function (PDF) of the observations from the data pooling procedure 210, Xᵢ, can be represented by Equation 1 where Zᵢ∈{1, . . . , K} represents a latent variable representing the mixture component for Xᵢ.

$$P ( {X}_{i} = x ) = {\sum }_{k = 1}^{K} {ϕ}_{k} P ( {X}_{i} = x \vert {Z}_{i} = k ) \qquad ( 1 )$$

Moreover, as shown in Equation 1, P (Xᵢ|Zᵢ) may represent the mixture component and ok may represent the mixture proportion that represents the probability that an observation, Xᵢ, belongs to the k-th mixture component. Further, N (μ, Σ) may denote the PDF for a normal random variable with a mean μ and a covariance matrix Σ. Therefore, the conditional distribution may follow a normal distribution as shown in Equation 2 such that the PDF of Xᵢ is represented by Equation 3.

$${X}_{i} \vert {Z}_{i} = k ∼ N ( {μ}_{k} , {σ}_{k}^{2} ) \qquad ( 2 )$$

$$P ( {X}_{i} = x ) = {\sum }_{k = 1}^{K} {ϕ}_{k} N ( x ; {μ}_{k} , {\sum }_{k} ) \qquad ( 3 )$$

In Equation 3 above, K may represent a hyper-parameter for the probabilistic mixture model 215 that is a predefined value selected before the training of the probabilistic mixture model 215. A hyper-parameter may be a parameter that is generated by human or user experience through one or more data observations or model experiments. Moreover, the unknown parameters with the probabilistic mixture model 215 may learn using the global data from the data pooling procedure 210 may be a cluster proportions parameter 220, a cluster means parameter 225, and a cluster covariance parameter 230 which may be represented by ϕₖ, μₖ, and ⊖ₖ respectively. The estimates of those parameters generated by the probabilistic mixture model 215 may be denoted as [symbol] , [symbol] , and [symbol] respectively, where the superscript g represents that the parameter is a global parameter for a set of users 205.

In some examples, the user 205-a may have a relatively small quantity of data or a lack of any data to train a ML model. Thus, the user 205-a may use a cloned global modeling procedure 235 to generate a local model 240-a for the user 205-a. For example, the user 205-a may use the cluster proportions parameter 220, the parameter 225, and the cluster covariance parameter 230, generated by the probabilistic mixture model 215 to train the local model 240-a. In some cases, in the cloned global modeling procedure 235 to generate the local model 240-a for the user 205-a, the user 205-a may use an expectation-maximization (EM) training algorithm.

The EM training algorithm attempts to find a maximum likelihood estimation for models with latent variables (e.g., variables that are inferred from a mathematical model or a ML model). In some cases, the techniques of the EM training algorithm may be implemented via one or more computer programs or methods and functions of computer programming language libraries. Each iteration of the EM training algorithm may include a first step for expectation estimation (e.g., the E-step) and a second step for maximization estimation (e.g., the M-step). To start, the global training parameters may be initialized as

$$( 0 ) , ( 0 ) and ( 0 )$$

with random variables and the log-likelihood of these parameters may be calculated. For example, for n observations, X₁, . . . , Xₙ, the log-likelihood may be calculated via Equation 4 where t denotes the t-th iteration.

$$L ( θ ( t ) ) = {\sum }_{i = 1}^{n} log ( {\sum }_{k = 1}^{K} ( t ) N ( {x}_{i} ; ( t ) , ( t ) ) ) \qquad ( 4 )$$

In the E-step of the EM training algorithm, the posterior probability, Pₜ (Zᵢ=k|Xᵢ), may be calculated using the current values of

$$( t ) , ( t ) , and ( t ) .$$

In some cases, the posterior probability may be calculated to predict the probability of an event occurring after consideration of additional information (e.g., local user 205 data, global user 205 data, or both). The posterior probability, Pₜ (Zᵢ=k|Xᵢ), may further be denoted as

$${r}_{i , k}^{g} ( t ) ,$$

such that the posterior probability can be calculated via Equation 5.

$${P}_{t} ( {X}_{i} ) = {r}_{i , k}^{g} ( t ) = \frac{P ( {Z}_{i} = k ) P ( {Z}_{i} = k )}{P ( {X}_{i} )} = \frac{( t ) N ( ( t ) , ( t ) )}{{\sum }_{k = 1}^{K} ( t ) N ( ( t ) , ( t ) )} \qquad ( 5 )$$

In the M-step of the EM training algorithm, the cluster proportions parameter 220, the parameter 225, and the cluster covariance parameter 230

$$( e . g . , ( t + 1 ) , ( t + 1 ) , and ( t + 1 ) )$$

with the current values of Pₜ (Zᵢ=k|Xᵢ). Further, an effective quantity of points assigned to a cluster k may be calculated by Equation 6. Moreover, the values for the cluster proportions parameter 220, the parameter 225, and the cluster covariance parameter 230, may be calculated by Equations 7 through 9 accordingly. After calculating the values for the respective global training parameters, the log-likelihood may be reevaluated via Equation 4 using the values calculated in Equations 7 through 9. If the value of the reevaluated log-likelihood, L(θ(t)), changes by a relatively small amount, ∈, then the EM algorithm may conclude. Otherwise, the EM algorithm may reinitiate the E-step and the M-step of the EM algorithm.

$${N}_{k} = {\sum }_{i = 1}^{n} {r}_{i , k}^{g} ( t ) \qquad ( 6 )$$

$$( t + 1 ) = \frac{{N}_{k}}{n} \qquad ( 7 )$$

$$( t + 1 ) = \frac{1}{{N}_{k}} {\sum }_{i = 1}^{n} {r}_{i , k}^{g} ( t ) {x}_{i} \qquad ( 8 )$$

$$( t + 1 ) = \frac{1}{{N}_{k}} {\sum }_{i = 1}^{n} {r}_{i , k}^{g} ( t ) {( {x}_{i} - ( t ) )}^{T} ( {x}_{i} - ( t ) ) \qquad ( 9 )$$

In some examples, while the user 205-a may lack any data for training the local model 240-a, the user 205-b may have some data for training a local model 240 (e.g., the local model 240-b). However, since a quantity of data (e.g., local data samples) available for the user 205-b may be relatively small, the user 205-b may be unable to generate estimates of all the global training parameters using the local data. Therefore, in accordance with the techniques of the present disclosure, the user 205-b may perform a fine-tuning procedure 245 (e.g., a fine-tuning procedure 245-a) to tune a part of the global training parameters using the local data before performing a local model training procedure 250 (e.g., a local model training procedure 250-a). For example, since the cluster proportions parameter 220, ϕₖ may have at most K estimates, the user 205-b may be capable of tuning the cluster proportions parameter 220 using local data and continue using the cluster means parameter 225, [symbol] , and the cluster covariance parameter 230, [symbol] , that are generated by the probabilistic mixture model 215.

Further, in some cases, if a respective user 205 (e.g., the user 205-b) is associated with an organization that shares a customer base with other organizations associated with other users (e.g., the user 205-a, the user 205-c, and the user 205-d), it may be beneficial to use the global training parameters. For example, if each user 205 whose data is pooled together via the data pooling procedure 210 is associated with a similar industry the global training parameters may be relatively accurate for each respective user. Thus, in accordance with the techniques of the present disclosure, to enhance (e.g., boost) the performance of the local model training procedure 250-a to train the local model 240-b, the user 205-b may perform the fine-tuning procedure 245-a to generate a local cluster proportion, [symbol] .Moreover, l may denote that the respective training parameter is based on local data rather than global data (e.g., training parameters denoted by g).

To start the fine-tuning procedure 245-a, a local cluster proportion parameter may be initialized to be equal to the cluster proportions parameter 220 that is based on global data and is generated by the probabilistic mixture model 215

$$( e . g . , ( 0 ) = ) .$$

Following, the log-likelihood with the respective parameters may be generated for n observations, X₁, . . . , Xₙ, as shown in Equation 10 below where t denotes the t-th iteration.

$$L ( θ ( t ) ) = {\sum }_{i = 1}^{n} log ( {\sum }_{k = 1}^{K} ( t ) N ( {x}_{i} ; ( t ) , ( t ) ) ) \qquad ( 10 )$$

Thus, following the EM algorithm described herein, in the E-step the posterior probability, Pₜ(Zᵢ=k|Xᵢ), may be calculated using the current value of

$$( 0 )$$

as shown in Equation 11 below where the posterior probability can be denoted as

$${r}_{i , k}^{l} ( t ) .$$

Based on evaluating the posterior probability, in the M-step of the EM algorithm, the additional parameters

$$( t + 1 ) ,$$

may be calculated with the current values of Pₜ (Zᵢ=k|Xᵢ). For example, an effective quantity of points assigned to a cluster, k, may be calculated using Equation 12 and the cluster proportions parameter 220 that is tuned via the fine-tuning procedure 245-a using local data of the user 205-b may be calculated using Equation 13 below. Then, the user 205-b may evaluate the log-likelihood using the updated parameters and if the log-likelihood has changed by a relatively small amount, E, the EM algorithm may be concluded, otherwise, the algorithm may be reinitiated starting at the E-step using Equation 11.

$${P}_{t} ( {X}_{i} ) = {r}_{i , k}^{l} ( t ) = \frac{P ( {Z}_{i} = k ) P ( {Z}_{i} = k )}{P ( {X}_{i} )} = \frac{( t ) N ( ( t ) , ( t ) )}{{\sum }_{k = 1}^{K} ( t ) N ( ( t ) , ( t ) )} \qquad ( 11 )$$

$${N}_{k} = {\sum }_{i = 1}^{n} {r}_{i , k}^{l} ( t ) \qquad ( 12 )$$

$$( t + 1 ) = \frac{{N}_{k}}{n} \qquad ( 13 )$$

In some cases, a user 205 may be able to calculate or determine a quantity of local clusters using the cluster proportions parameter 220, ϕₖ. For example, a quantity of local cluster counts, C, may be less than a quantity of global cluster counts, K (e.g., C≤K). In some examples, the quantity of local cluster counts may be a hyperparameter (e.g., preconfigured before training of a local model 240). In some other examples, the quantity of local cluster counts may be undetermined and may be chosen based on the [symbol] estimates, where l is used to denote a local training parameter. For example, the quantity of local cluster counts may be selected with the highest [symbol] such that the sum satisties a pre-defined threshold τ, where the threshold is between the values of 0 and 1 (e.g., 0<τ≤1). Therefore, the value of the [symbol] may be set to zero for un-selected clusters and can be proportionally scaled upwards for the selected clusters. Such procedure may be useful for removing unwanted noise, however, for simplicity, the quantity of local cluster counts, C, may be set equal to the quantity of global cluster counts, K, as described elsewhere here. Although, it should be understood by one having ordinary skill in the art that the value of the quantity of local cluster counts may be different (e.g., greater than or less than) the value of the quantity of global cluster counts.

In some examples, for users 205 (e.g., the user 205-c) with more data available for ML model training (e.g., double the volume of data compared to the user 205-b), the user 205-c may perform a fine-tuning procedure 245-b on additional global training parameters to perform a local model training procedure 250-b for training the local model 240-c. For example, the user 205-c may perform the fine-tuning procedure 245-b on both the cluster proportions parameter 220 and the parameter 225 to enhance the training and performance of the local model 240-c. Using the EM algorithm, a local cluster proportions parameter and a local cluster means parameter may first be initialized to be equal to their respective global training parameters

$$( e . g . , ( 0 ) = and ( 0 ) = ) .$$

Then, the log-likelihood for n observations, X₁, . . . , Xₙ, may be evaluated using the local training parameters as shown in Equation 14 below where t denotes the t-th iteration. During the E-step of the EM algorithm, the user 205-c may evaluate the posterior probability, Pₜ (Zᵢ=k|Xᵢ), that can be denoted by

$${r}_{i , k}^{l} ( t ) ,$$

using the current values of the local cluster proportions parameter,

$$( t )$$

and the local cluster means parameter,

$$( t )$$

as shown in Equation 15. Moreover, during the M-step of the EM algorithm, an effective quantity of points assigned to a cluster, k, may be evaluated via Equation 12. Further, the user 205-c may use the current values of Pₜ(Zᵢ=k|Xᵢ) to evaluate the local cluster proportions parameter,

$$( t + 1 )$$

as shown in Equation 13 and the local cluster means parameter,

$$( t + 1 )$$

as shown in Equation 16. Then, the user 205-b may evaluate the log-likelihood using the updated parameters and if the log-likelihood has changed by a relatively small amount, ∈, the EM algorithm may be concluded, otherwise, the algorithm may be reinitiated starting at the E-step using Equation 15.

$$L ( θ ( t ) ) = {\sum }_{i = 1}^{n} log ( {\sum }_{k = 1}^{K} ( t ) N ( {x}_{i} ; ( t ) , ( t ) ) ) \qquad ( 14 )$$

$${P}_{t} ( {X}_{i} ) = {r}_{i , k}^{l} ( t ) = \frac{P ( {Z}_{i} = k ) P ( {Z}_{i} = k )}{P ( {X}_{i} )} = \frac{( t ) N ( ( t ) , ( t ) )}{{\sum }_{k = 1}^{K} ( t ) N ( ( t ) , ( t ) )} \qquad ( 15 )$$

$$( t + 1 ) = \frac{1}{{N}_{k}} {\sum }_{i = 1}^{n} {r}_{i , k}^{l} ( t ) {x}_{i} \qquad ( 16 )$$

In some other examples, some users 205 (e.g., the user 205-d) may have a relatively large quantity of data available for performing a local model training procedure 250 (e.g., a local model training procedure 250-c). Thus, in accordance with the techniques of the present disclosure, to enhance (e.g., boost) the performance of the local model training procedure 250-c to generate and train a local model 240-d, the user 205-d may perform a fine-tuning procedure 245-c to fine tune the cluster proportions parameter 220, the cluster means parameter 225, and the cluster covariance parameter 230 using local data. To fine-tune all the global training parameters, the steps may be similar to training a model with the global training parameters alone (e.g., as done for the user 205-a due to a lack of local sample data available) except that the initial values of the local model parameters may be based on the global model training parameters rather than being random.

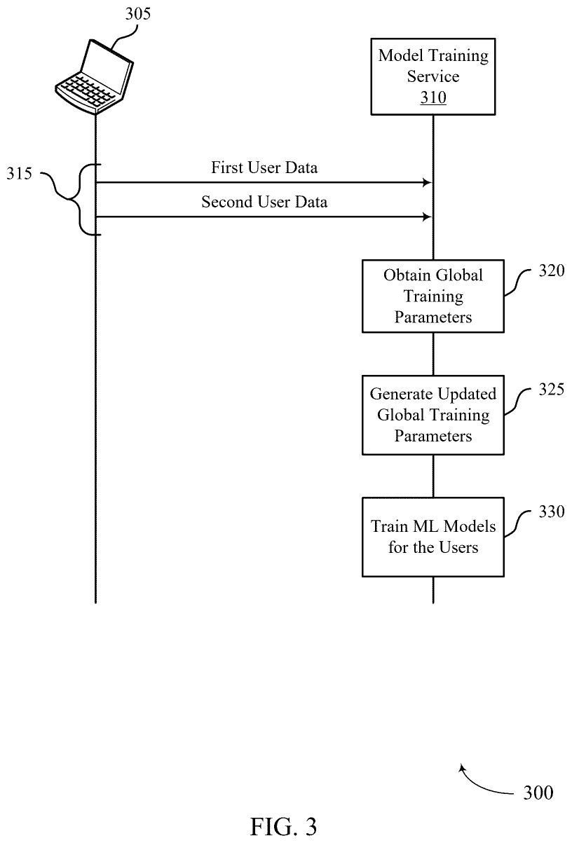

Thus, the techniques of the present disclosure may enable users 205 to train local models 240 using user-specific data and global data (e.g., data pooled from the user 205-a, the user 205-b, the user 205-c, and the user 205-d) to enhance the training and performance of the respective local models 240. For example, users 205 with relatively low quantities of data samples for training a respective local model 240 may be capable of fine tuning a single global training parameter using data specific to the respective user 205 and using the other global training parameters as-is to enhance the performance of the respective local model 240. Therefore, the techniques of the present disclosure may enhance the training of local models 240 to enable users 205 to obtain more accurate, efficient, and reliable predictions on user-specific data (e.g., customer data) such as customer segmentation predictions. Further descriptions of the techniques of the present disclosure may be described elsewhere herein, such as with reference to FIG. 3.

FIG. 3 shows an example of a process flow 300 that supports user-specific model training using data from a set of users and probabilistic mixture models in accordance with aspects of the present disclosure. In some examples, the process flow 300 may implement or be implemented by the system 100, the model training flow diagram 200, or both. For example, the process flow 300 may include a computing device 305 and a model training service 310, which may be examples of devices described herein with reference to FIG. 1.

In the following description of the process flow 300, the operations between the computing device 305 and the model training service 310 may be performed in different orders or at different times. Some operations may also be left out of the process flow 300, or other operations may be added. Although the computing device 305 and the model training service 310 are shown performing the operations of the process flow 300, some aspects of some operations may also be performed by one or more other wireless devices.

At 315, the computing device 305 may transmit, to the model training service 310, a first set of data associated with a first user and a second set of data associated with a second user may be received from a plurality of users. Moreover, the size of the second set of data may be different from the size of the first set of data. In some examples, the first user and the second user of the set of users may be associated with a first tenant and a second tenant of a set of tenants of a multi-tenant system. Further in some cases, a combined set of data that includes the first set of data associated with the first user and the second set of data associated with the second user may be generated based on receiving the first set of data and the second set of data.

At 320, the model training service 310 may input, into a probabilistic mixture model, the first set of data and the second set of data to obtain a set of global training parameters associated with the set of users. The set of global training parameters may include a first parameter associated with cluster proportions, a second parameter associated with cluster means, and a third parameter associated with a cluster covariance. In some cases, the probabilistic mixture model may be a Gaussian mixture model.

At 325, the model training service 310 may generate at least one updated global training parameter for training a first ML model associated with the first user and at least one updated global training parameter for training a second ML model associated with the second user. The quantity of updated global training parameters generated for training a respective ML model associated with a respective user may be based on the size of a set of data associated with the respective user. In some cases, the model training service 310 may perform a training parameter calibration procedure on at least one global training parameter using the set of data associated with the respective user to generate at least one updated global training parameter (e.g., to fine-tune a global training parameter). In some examples, the model training service 310 may receive an indication of an update to the first set of data, the second set of data, or both from the first user, the second user, or both. The quantity of updated global training parameters generated for the first user, the second user, or both may be based on the update to the first set of data, the second set of data, or both. Further, the update to the first set of data, the second set of data, or both may include an addition of one or more data items, a removal of one or more data items, or both.

At 330, the model training service 310 may train a respective ML model for a respective user using both the at least one updated global training parameter, a remainder of non-updated global training parameters, and the set of data associated with the respective user. In some cases, the model training service 310 may receive, from a third user of the computing device 305, a request to generate an ML model for the third user. In some examples, the third user may lack a third set of data. Thus, the model training service 310 may train the third ML model for the third user using the set of global training parameters obtained from inputting the first set of data associated with the first user and the second set of data associated with the second user into the probabilistic mixture model.

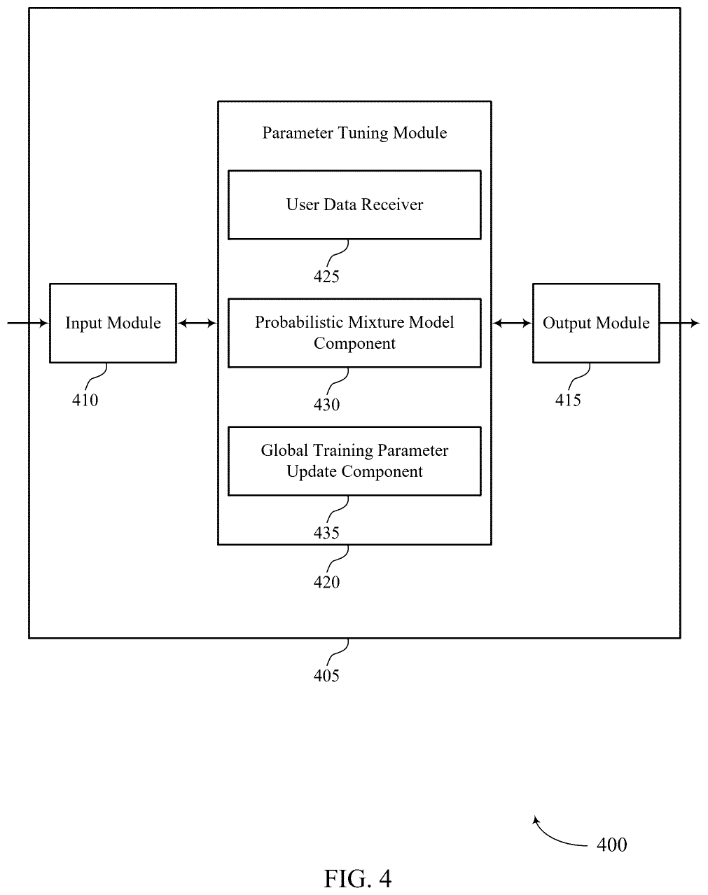

FIG. 4 shows a block diagram 400 of a device 405 that supports user-specific model training using data from a set of users and probabilistic mixture models in accordance with aspects of the present disclosure. The device 405 may include an input module 410, an output module 415, and a parameter tuning module 420. The device 405, or one or more components of the device 405 (e.g., the input module 410, the output module 415, the parameter tuning module 420), may include at least one processor, which may be coupled with at least one memory, to support the described techniques. Each of these components may be in communication with one another (e.g., via one or more buses).

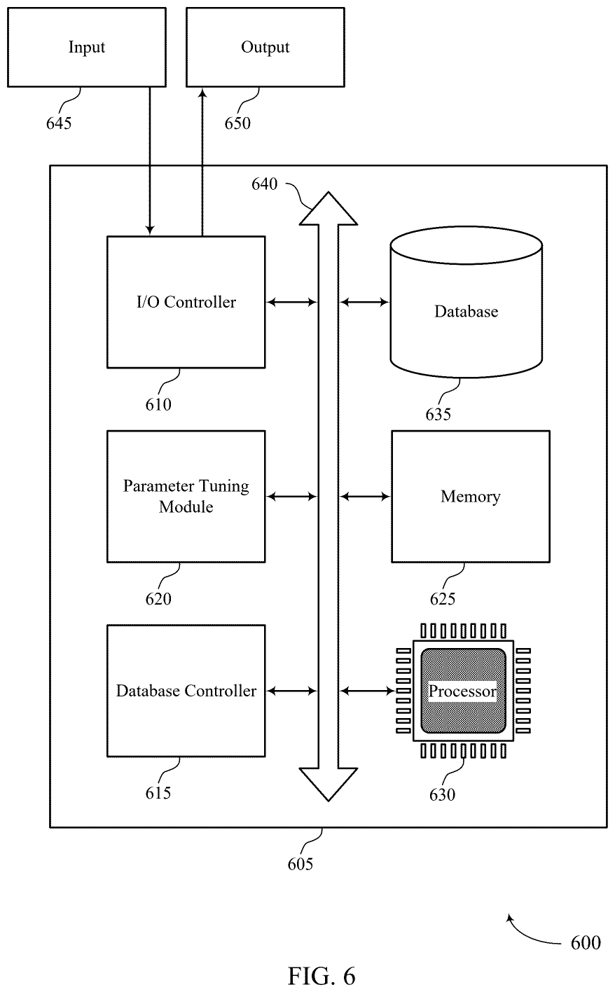

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the parameter tuning module 420 to support user-specific model training using data from a set of users and probabilistic mixture models. In some cases, the input module 410 may be a component of an input/output (I/O) controller 610 as described with reference to FIG. 6.

The output module 415 may manage output signals for the device 405. For example, the output module 415 may receive signals from other components of the device 405, such as the parameter tuning module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the parameter tuning module 420 may include a user data receiver 425, a probabilistic mixture model component 430, a global training parameter update component 435, or any combination thereof. In some examples, the parameter tuning module 420, or various components thereof, may be configured to perform various operations (e.g., receiving, monitoring, transmitting) using or otherwise in cooperation with the input module 410, the output module 415, or both. For example, the parameter tuning module 420 may receive information from the input module 410, send information to the output module 415, or be integrated in combination with the input module 410, the output module 415, or both to receive information, transmit information, or perform various other operations as described herein.

The parameter tuning module 420 may support fine-tuning a user-specific ML model in accordance with examples as disclosed herein. The user data receiver 425 may be configured to support receiving, from a first user and a second user of a set of multiple users, a first set of data associated with the first user and a second set of data associated with the second user, where a size of the second set of data is different from a size of the first set of data. The probabilistic mixture model component 430 may be configured to support inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance. The global training parameter update component 435 may be configured to support generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

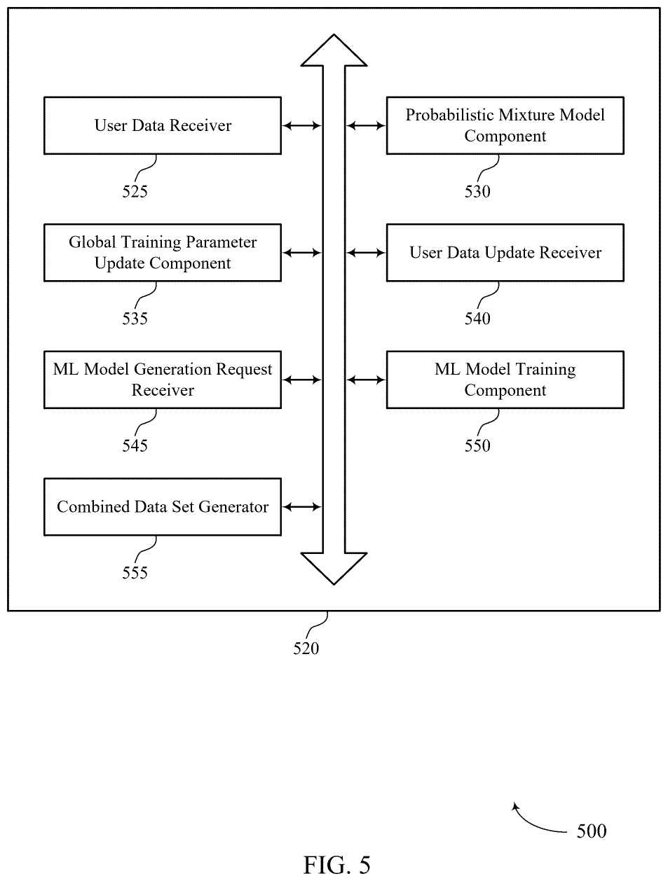

FIG. 5 shows a block diagram 500 of a parameter tuning module 520 that supports user-specific model training using data from a set of users and probabilistic mixture models in accordance with aspects of the present disclosure. The parameter tuning module 520 may be an example of aspects of a parameter tuning module or a parameter tuning module 420, or both, as described herein. The parameter tuning module 520, or various components thereof, may be an example of means for performing various aspects of user-specific model training using data from a set of users and probabilistic mixture models as described herein. For example, the parameter tuning module 520 may include a user data receiver 525, a probabilistic mixture model component 530, a global training parameter update component 535, a user data update receiver 540, an ML model generation request receiver 545, an ML model training component 550, a combined data set generator 555, or any combination thereof. Each of these components, or components of subcomponents thereof (e.g., one or more processors, one or more memories), may communicate, directly or indirectly, with one another (e.g., via one or more buses).

The parameter tuning module 520 may support fine-tuning a user-specific ML model in accordance with examples as disclosed herein. The user data receiver 525 may be configured to support receiving, from a first user and a second user of a set of multiple users, a first set of data associated with the first user and a second set of data associated with the second user, where a size of the second set of data is different from a size of the first set of data. The probabilistic mixture model component 530 may be configured to support inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance. The global training parameter update component 535 may be configured to support generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

In some examples, the user data update receiver 540 may be configured to support receiving, from the first user, the second user, or both, an indication of an update to the first set of data, the second set of data, or both, where the quantity of updated global training parameters generated for the first user, the second user, or both is based on the update to the first set of data, the second set of data, or both.

In some examples, the update to the first set of data, the second set of data, or both includes an addition of one or more data items, a removal of one or more data items, or both.

In some examples, the ML model generation request receiver 545 may be configured to support receiving, from a third user, a request to generate a ML model for the third user, where the third user lacks a third set of data. In some examples, the ML model training component 550 may be configured to support training a third ML model for the third user using the set of global training parameters obtained from inputting the first set of data associated with the first user and the second set of data associated with the second user into the probabilistic mixture model.

In some examples, the combined data set generator 555 may be configured to support generating, based on receiving the first set of data and the second set of data, a combined set of data that includes the first set of data associated with the first user and the second set of data associated with the second user, where inputting the first set of data and the second set of data into the probabilistic mixture model includes inputting the combined set of data into the probabilistic mixture model.

In some examples, to support generating the at least one updated global training parameter, the global training parameter update component 535 may be configured to support performing a training parameter calibration procedure on at least one global training parameter using the set of data associated with the respective user.

In some examples, the ML model training component 550 may be configured to support training the respective ML model for the respective user using both the at least one updated global training parameter, a remainder of non-updated global training parameters, and the set of data associated with the respective user.

In some examples, the probabilistic mixture model is a Gaussian mixture model.

In some examples, the first user and the second user of the set of multiple users are associated with a first tenant and a second tenant of a set of multiple tenants of a multi-tenant system.

FIG. 6 shows a diagram of a system 600 including a device 605 that supports user-specific model training using data from a set of users and probabilistic mixture models in accordance with aspects of the present disclosure. The device 605 may be an example of or include components of a device 405 as described herein. The device 605 may include components for bi-directional data communications including components for transmitting and receiving communications, such as a parameter tuning module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting user-specific model training using data from a set of users and probabilistic mixture models). The processor 630 may be an example of a single processor or multiple processors. For example, the device 605 may include one or more processors 630.

The parameter tuning module 620 may support fine-tuning a user-specific ML model in accordance with examples as disclosed herein. For example, the parameter tuning module 620 may be configured to support receiving, from a first user and a second user of a set of multiple users, a first set of data associated with the first user and a second set of data associated with the second user, where a size of the second set of data is different from a size of the first set of data. The parameter tuning module 620 may be configured to support inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance. The parameter tuning module 620 may be configured to support generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

By including or configuring the parameter tuning module 620 in accordance with examples as described herein, the device 605 may support techniques for fine-tuning user-specific ML models by using global training parameters for ML model training to support ML models generating more accurate and reliable results.

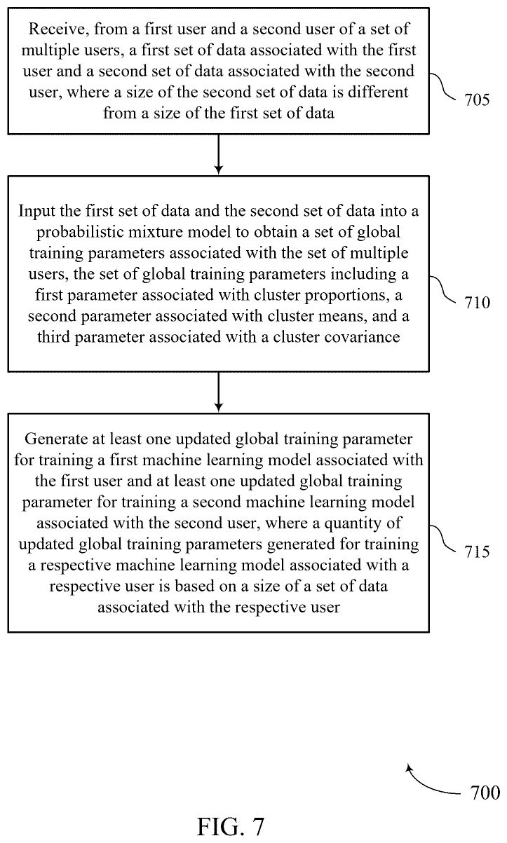

FIG. 7 shows a flowchart illustrating a method 700 that supports user-specific model training using data from a set of users and probabilistic mixture models in accordance with aspects of the present disclosure. The operations of the method 700 may be implemented by an ML model training service or its components as described herein. For example, the operations of the method 700 may be performed by an ML model training service as described with reference to FIGS. 1 through 6. In some examples, an ML model training service may execute a set of instructions to control the functional elements of the ML model training service to perform the described functions. Additionally, or alternatively, the ML model training service may perform aspects of the described functions using special-purpose hardware.

At 705, the method may include receiving, from a first user and a second user of a set of multiple users, a first set of data associated with the first user and a second set of data associated with the second user, where a size of the second set of data is different from a size of the first set of data. The operations of 705 may be performed in accordance with examples as disclosed herein. In some examples, aspects of the operations of 705 may be performed by a user data receiver 525 as described with reference to FIG. 5.

At 710, the method may include inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance. The operations of 710 may be performed in accordance with examples as disclosed herein. In some examples, aspects of the operations of 710 may be performed by a probabilistic mixture model component 530 as described with reference to FIG. 5.

At 715, the method may include generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user. The operations of 715 may be performed in accordance with examples as disclosed herein. In some examples, aspects of the operations of 715 may be performed by a global training parameter update component 535 as described with reference to FIG. 5.

A method for fine-tuning a user-specific ML model by an apparatus is described. The method may include receiving, from a first user and a second user of a set of multiple users, a first set of data associated with the first user and a second set of data associated with the second user, where a size of the second set of data is different from a size of the first set of data, inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance, and generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

An apparatus for fine-tuning a user-specific ML model is described. The apparatus may include one or more memories storing processor executable code, and one or more processors coupled with the one or more memories. The one or more processors may individually or collectively be operable to execute the code to cause the apparatus to receive, from a first user and a second user of a set of multiple users, a first set of data associated with the first user and a second set of data associated with the second user, where a size of the second set of data is different from a size of the first set of data, input the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance, and generate at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

Another apparatus for fine-tuning a user-specific ML model is described. The apparatus may include means for receiving, from a first user and a second user of a set of multiple users, a first set of data associated with the first user and a second set of data associated with the second user, where a size of the second set of data is different from a size of the first set of data, means for inputting the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance, and means for generating at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

A non-transitory computer-readable medium storing code for fine-tuning a user-specific ML model is described. The code may include instructions executable by one or more processors to receive, from a first user and a second user of a set of multiple users, a first set of data associated with the first user and a second set of data associated with the second user, where a size of the second set of data is different from a size of the first set of data, input the first set of data and the second set of data into a probabilistic mixture model to obtain a set of global training parameters associated with the set of multiple users, the set of global training parameters including a first parameter associated with cluster proportions, a second parameter associated with cluster means, and a third parameter associated with a cluster covariance, and generate at least one updated global training parameter for training a first ML model associated with the first user and at least one updated global training parameter for training a second ML model associated with the second user, where a quantity of updated global training parameters generated for training a respective ML model associated with a respective user is based on a size of a set of data associated with the respective user.

Some examples of the method, apparatus, and non-transitory computer-readable medium described herein may further include operations, features, means, or instructions for receiving, from the first user, the second user, or both, an indication of an update to the first set of data, the second set of data, or both, where the quantity of updated global training parameters generated for the first user, the second user, or both may be based on the update to the first set of data, the second set of data, or both.

In some examples of the method, apparatus, and non-transitory computer-readable medium described herein, the update to the first set of data, the second set of data, or both includes an addition of one or more data items, a removal of one or more data items, or both.

Some examples of the method, apparatus, and non-transitory computer-readable medium described herein may further include operations, features, means, or instructions for receiving, from a third user, a request to generate a ML model for the third user, where the third user lacks a third set of data and training a third ML model for the third user using the set of global training parameters obtained from inputting the first set of data associated with the first user and the second set of data associated with the second user into the probabilistic mixture model.

Some examples of the method, apparatus, and non-transitory computer-readable medium described herein may further include operations, features, means, or instructions for generating, based on receiving the first set of data and the second set of data, a combined set of data that includes the first set of data associated with the first user and the second set of data associated with the second user, where inputting the first set of data and the second set of data into the probabilistic mixture model includes inputting the combined set of data into the probabilistic mixture model.

In some examples of the method, apparatus, and non-transitory computer-readable medium described herein, generating the at least one updated global training parameter may include operations, features, means, or instructions for performing a training parameter calibration procedure on at least one global training parameter using the set of data associated with the respective user.

Some examples of the method, apparatus, and non-transitory computer-readable medium described herein may further include operations, features, means, or instructions for training the respective ML model for the respective user using both the at least one updated global training parameter, a remainder of non-updated global training parameters, and the set of data associated with the respective user.

In some examples of the method, apparatus, and non-transitory computer-readable medium described herein, the probabilistic mixture model may be a Gaussian mixture model.

In some examples of the method, apparatus, and non-transitory computer-readable medium described herein, the first user and the second user of the set of multiple users may be associated with a first tenant and a second tenant of a set of multiple tenants of a multi-tenant system.

The following provides an overview of aspects of the present disclosure:

Aspect 1: A method for fine-tuning a user-specific ML model, comprising: receiving, from a first user and a second user of a plurality of users, a first set of data associated with the first user and a second set of data associated with the second user, wherein a size of the second set of data is different from a size of the first set of data; inputting the first set of data and the second set of data into a probabilistic mixture model to obtain a set of global training parameters associated with the plurality of users, the set of global training parameters comprising a first parameter associated with cluster proportions, a second parameter associated with cluster means, and a third parameter associated with a cluster covariance; and generating at least one updated global training parameter for training a first ML model associated with the first user and at least one updated global training parameter for training a second ML model associated with the second user, wherein a quantity of updated global training parameters generated for training a respective ML model associated with a respective user is based at least in part on a size of a set of data associated with the respective user.

Aspect 2: The method of aspect 1, further comprising: receiving, from the first user, the second user, or both, an indication of an update to the first set of data, the second set of data, or both, wherein the quantity of updated global training parameters generated for the first user, the second user, or both is based at least in part on the update to the first set of data, the second set of data, or both.

Aspect 3: The method of aspect 2, wherein the update to the first set of data, the second set of data, or both comprises an addition of one or more data items, a removal of one or more data items, or both.

Aspect 4: The method of any of aspects 1 through 3, further comprising: receiving, from a third user, a request to generate a ML model for the third user, wherein the third user lacks a third set of data; and training a third ML model for the third user using the set of global training parameters obtained from inputting the first set of data associated with the first user and the second set of data associated with the second user into the probabilistic mixture model.

Aspect 5: The method of any of aspects 1 through 4, further comprising: generating, based at least in part on receiving the first set of data and the second set of data, a combined set of data that comprises the first set of data associated with the first user and the second set of data associated with the second user, wherein inputting the first set of data and the second set of data into the probabilistic mixture model comprises inputting the combined set of data into the probabilistic mixture model.

Aspect 6: The method of any of aspects 1 through 5, wherein generating the at least one updated global training parameter comprises: performing a training parameter calibration procedure on at least one global training parameter using the set of data associated with the respective user.

Aspect 7: The method of any of aspects 1 through 6, further comprising: training the respective ML model for the respective user using both the at least one updated global training parameter, a remainder of non-updated global training parameters, and the set of data associated with the respective user.

Aspect 8: The method of any of aspects 1 through 7, wherein the probabilistic mixture model is a Gaussian mixture model.

Aspect 9: The method of any of aspects 1 through 8, wherein the first user and the second user of the plurality of users are associated with a first tenant and a second tenant of a plurality of tenants of a multi-tenant system.

Aspect 10: An apparatus for fine-tuning a user-specific ML model, comprising one or more memories storing processor-executable code, and one or more processors coupled with the one or more memories and individually or collectively operable to execute the code to cause the apparatus to perform a method of any of aspects 1 through 9.

Aspect 11: An apparatus for fine-tuning a user-specific ML model, comprising at least one means for performing a method of any of aspects 1 through 9.

Aspect 12: A non-transitory computer-readable medium storing code for fine-tuning a user-specific ML model, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for fine-tuning a user-specific machine learning model, comprising:
receiving, from a first user and a second user of a plurality of users, a first set of data associated with the first user and a second set of data associated with the second user, wherein a size of the second set of data is different from a size of the first set of data;
inputting the first set of data and the second set of data into a probabilistic mixture model to obtain a set of global training parameters associated with the plurality of users, the set of global training parameters comprising a first parameter associated with cluster proportions, a second parameter associated with cluster means, and a third parameter associated with a cluster covariance; and
generating at least one updated global training parameter for training a first machine learning model associated with the first user and at least one updated global training parameter for training a second machine learning model associated with the second user, wherein a quantity of updated global training parameters generated for training a respective machine learning model associated with a respective user is based at least in part on a size of a set of data associated with the respective user.

2. The method of claim 1, further comprising:
receiving, from the first user, the second user, or both, an indication of an update to the first set of data, the second set of data, or both, wherein the quantity of the updated global training parameters generated for the first user, the second user, or both is based at least in part on the update to the first set of data, the second set of data, or both.

3. The method of claim 2, wherein the update to the first set of data, the second set of data, or both comprises an addition of one or more data items, a removal of one or more data items, or both.

4. The method of claim 1, further comprising:
receiving, from a third user, a request to generate a machine learning model for the third user, wherein the third user lacks a third set of data; and
training a third machine learning model for the third user using the set of global training parameters obtained from inputting the first set of data associated with the first user and the second set of data associated with the second user into the probabilistic mixture model.

5. The method of claim 1, further comprising:
generating, based at least in part on receiving the first set of data and the second set of data, a combined set of data that comprises the first set of data associated with the first user and the second set of data associated with the second user, wherein inputting the first set of data and the second set of data into the probabilistic mixture model comprises inputting the combined set of data into the probabilistic mixture model.

6. The method of claim 1, wherein generating the at least one updated global training parameter comprises:
performing a training parameter calibration procedure on at least one global training parameter using the set of data associated with the respective user.

7. The method of claim 1, further comprising:
training the respective machine learning model for the respective user using both the at least one updated global training parameter, a remainder of non-updated global training parameters, and the set of data associated with the respective user.

8. The method of claim 1, wherein the probabilistic mixture model is a Gaussian mixture model.

9. The method of claim 1, wherein the first user and the second user of the plurality of users are associated with a first tenant and a second tenant of a plurality of tenants of a multi-tenant system.

10. An apparatus for fine-tuning a user-specific machine learning model, comprising:
one or more memories storing processor-executable code; and
one or more processors coupled with the one or more memories and individually or collectively operable to execute the code to cause the apparatus to:
receive, from a first user and a second user of a plurality of users, a first set of data associated with the first user and a second set of data associated with the second user, wherein a size of the second set of data is different from a size of the first set of data;
input the first set of data and the second set of data into a probabilistic mixture model to obtain a set of global training parameters associated with the plurality of users, the set of global training parameters comprising a first parameter associated with cluster proportions, a second parameter associated with cluster means, and a third parameter associated with a cluster covariance; and
generate at least one updated global training parameter for training a first machine learning model associated with the first user and at least one updated global training parameter for training a second machine learning model associated with the second user, wherein a quantity of updated global training parameters generated for training a respective machine learning model associated with a respective user is based at least in part on a size of a set of data associated with the respective user.

11. The apparatus of claim 10, wherein the one or more processors are individually or collectively further operable to execute the code to cause the apparatus to:
receive, from the first user, the second user, or both, an indication of an update to the first set of data, the second set of data, or both, wherein the quantity of the updated global training parameters generated for the first user, the second user, or both is based at least in part on the update to the first set of data, the second set of data, or both.

12. The apparatus of claim 10, wherein the one or more processors are individually or collectively further operable to execute the code to cause the apparatus to:
receive, from a third user, a request to generate a machine learning model for the third user, wherein the third user lacks a third set of data; and
train a third machine learning model for the third user using the set of global training parameters obtained from inputting the first set of data associated with the first user and the second set of data associated with the second user into the probabilistic mixture model.

13. The apparatus of claim 10, wherein the one or more processors are individually or collectively further operable to execute the code to cause the apparatus to:
generate, based at least in part on receiving the first set of data and the second set of data, a combined set of data that comprises the first set of data associated with the first user and the second set of data associated with the second user, wherein inputting the first set of data and the second set of data into the probabilistic mixture model comprises inputting the combined set of data into the probabilistic mixture model.

14. The apparatus of claim 10, wherein, to generate the at least one updated global training parameter, the one or more processors are individually or collectively operable to execute the code to cause the apparatus to:
perform a training parameter calibration procedure on at least one global training parameter using the set of data associated with the respective user.

15. The apparatus of claim 10, wherein the one or more processors are individually or collectively further operable to execute the code to cause the apparatus to:
train the respective machine learning model for the respective user using both the at least one updated global training parameter, a remainder of non-updated global training parameters, and the set of data associated with the respective user.

16. A non-transitory computer-readable medium storing code for fine-tuning a user-specific machine learning model, the code comprising instructions executable by one or more processors to:
receive, from a first user and a second user of a plurality of users, a first set of data associated with the first user and a second set of data associated with the second user, wherein a size of the second set of data is different from a size of the first set of data;
input the first set of data and the second set of data into a probabilistic mixture model to obtain a set of global training parameters associated with the plurality of users, the set of global training parameters comprising a first parameter associated with cluster proportions, a second parameter associated with cluster means, and a third parameter associated with a cluster covariance; and
generate at least one updated global training parameter for training a first machine learning model associated with the first user and at least one updated global training parameter for training a second machine learning model associated with the second user, wherein a quantity of updated global training parameters generated for training a respective machine learning model associated with a respective user is based at least in part on a size of a set of data associated with the respective user.

17. The non-transitory computer-readable medium of claim 16, wherein the instructions are further executable by the one or more processors to:
receive, from a third user, a request to generate a machine learning model for the third user, wherein the third user lacks a third set of data; and
train a third machine learning model for the third user using the set of global training parameters obtained from inputting the first set of data associated with the first user and the second set of data associated with the second user into the probabilistic mixture model.

18. The non-transitory computer-readable medium of claim 16, wherein the instructions are further executable by the one or more processors to:
generate, based at least in part on receiving the first set of data and the second set of data, a combined set of data that comprises the first set of data associated with the first user and the second set of data associated with the second user, wherein inputting the first set of data and the second set of data into the probabilistic mixture model comprises inputting the combined set of data into the probabilistic mixture model.

19. The non-transitory computer-readable medium of claim 16, wherein the instructions to generate the at least one updated global training parameter are executable by the one or more processors to:
perform a training parameter calibration procedure on at least one global training parameter using the set of data associated with the respective user.

20. The non-transitory computer-readable medium of claim 16, wherein the instructions are further executable by the one or more processors to:
train the respective machine learning model for the respective user using both the at least one updated global training parameter, a remainder of non-updated global training parameters, and the set of data associated with the respective user.
